(19) United States
(12) Patent Application Publication
(10) Pub. No.: US 2005/0096221 A1
(43) Pub. Date: May 5, 2005

(54) Thermally-responsive record material

(75) Inventors: Mark Robert Fisher, Appleton, WI (US); Staceya Ann Justa MacNeil, Appleton, WI (US)

Correspondence Address: Appleton Papers Inc., 825 E. Wisconsin Avenue, P.O. Box 359, Appleton, WI, 54912-0359, US

(73) Assignee: Appleton Papers Inc., Appleton, WI (US)

(21) Appl. No.: 10/694,857

(22) Filed: Oct. 29, 2003

(51) Int. Cl. B41M 5/20

(52) U.S. Cl. 503/208

(57) ABSTRACT

An improved thermally-responsive record material with more intense imaging and resistance to fade when subjected to common environmental challenges is disclosed. The thermally responsive record material comprises a support having provided thereon a color-forming composite comprising chromogenic material and bis(4-hydroxy-3-allylphenyl) sulphone in combination with a compound of formula: 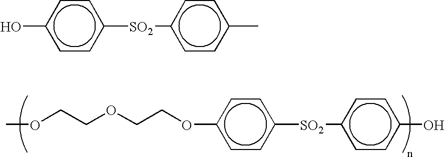 wherein n in an integer from 1 to 3.

### BACKGROUND OF THE INVENTION

1. Field of the Invention

This invention relates to a thermally-responsive record material. It more particularly relates to such record material in the form of sheets coated with color-forming systems comprising chromogenic material (electron-donating dye precursors) and acidic color developer material. This invention particularly concerns a thermally-responsive record material (thermal record material) capable of forming a substantially non-reversible image with improved color-forming efficiency and/or image density.

2. Description of the Background Art

Thermally-responsive record material systems are well known in the art and are described in many patents, for example: U.S. Pat. Nos. 3,539,375; 3,674,535; 3,746,675; 4,151,748; 4,181,771; 4,246,318 and 4,470,057 which are incorporated herein by reference. In these systems, basic chromogenic material and acidic color developer material are contained in a coating on a substrate which, when heated to a suitable temperature, melts or softens to permit said materials to react, thereby producing a colored mark.

Thermally-responsive record materials have characteristic thermal responses, desirably producing a color image upon selective thermal exposure.

In the field of thermally-responsive record material, thermal response is defined as the temperature at which a thermally-responsive record material produces a colored image of sufficient intensity (density). The desired temperature of imaging varies with the type of application of the thermally-responsive product and the equipment in which the imaging is to be performed.

Desirable features include the ability of a thermally-responsive record material to have improved imaging characteristics such as enhanced image intensity, image density, image retention, image stability, or improved thermal response.

Prior art thermally responsive record systems have the common drawback that the image erases when the color-forming layer is subjected to environmental challenges, particularly hand lotions and oils. Some systems try to overcome the problem by isolating or overcoating the color-forming layer. Such solutions however add expense, processing steps and are prone to premature erasure if the isolation means is compromised by wear or other reasons. A more stable chemistry is a particular sought after characteristic.

It is an object of the present invention to provide a thermally-responsive record material which is surprisingly resistant to image erasure when subjected to environmental challenges such as hand lotion and oils. A system exhibiting such image stability would be an advance in the art and of commercial significance.

### SUMMARY OF THE INVENTION

A thermally-responsive record material is disclosed comprising a support having provided thereon a color-forming composition comprising chromogenic material and bis(4-hydroxy-3-allylphenyl) sulphone in combination with a compound of formula: 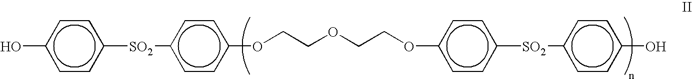
wherein n in an integer from about 1 to 3.

Preferably n is 2 or averages around 2.

The thermally-responsive color-forming composition can include in addition 4,4′-sulfonyl bisphenol.

Preferably the thermally-responsive record material includes in addition a topcoat selected from materials such as polyvinyl alcohol, carboxylated polyvinylalcohol, methylcellulose, ethyl cellulose, polyacrylamide, gelatin, starch, polyvinyl pyrrolidone, and the like.

In a preferred embodiment of the thermally-responsive record material the chromogenic material is a fluoran, and preferably 3-dibutylamino-6-methyl-7-anilino fluoran.

In addition a sensitizer such as a material selected from 1,2-diphenoxyethane, acetoacet-o-toluidine, phenyl-1-hydroxy-2-naphthoate, and p-benzyl biphenyl can be included.

In yet another embodiment, the thermally responsive record material includes in addition a backcoat.

In a further embodiment, the thermally-responsive record material color-forming composition can comprise one or more layers coated on the support, such as paper. For example, the chromogenic material or developer, or sensitizer, or a compound of formula I can be positioned in a separate layer from the compound of formula II. All such variations are within the scope of the invention contemplated herein.

### DETAILED DESCRIPTION

The present invention is a novel thermally-responsive record material comprising a substrate having coated thereon, in substantially contiguous relationship, a thermally-sensitive color-forming composition as a heat sensitive layer comprising a chromogenic material, and an acidic developer material whereby the melting or sublimination of the material produces a change in color reaction. The developer is a surprising combination of two materials. More surprisingly, neither material produces a similar response on its own. The developer is a unique combination of bis(4-hydroxy-3-allylphenyl) sulphone (I) and a compound of the formula: 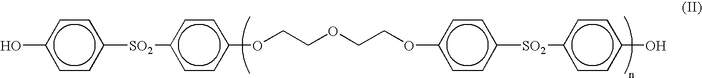
where n is an integer from 1 to 3. Preferably n is 2.

The combination in the color-forming composition of compounds I and II surprisingly leads to enhanced image retention resistant to environmental challenges such as exposure to hand lotion and oil.

Surprisingly, the intensity of the image and percent loss after environmental challenges are substantially improved as compared to other materials or when the materials are used alone or in other combinations. The compound I and compound II materials appear to cooperate in an unexpected fashion to yield an image of strong intensity, high contrast and surprisingly more resistant to fade when subjected to typical environmental challenges such as oil and hand lotion.

The thermally-responsive record material of the invention comprises a substrate bearing a thermally-sensitive color-forming composition coated on the substrate in one or more layers. The thermally-sensitive color-forming composition comprises an electron-donating dye precursor and the novel acidic developer material combination of the invention. The reactive color-forming composition constituents are in contiguous relationship, whereby the melting or sublimination of either material produces a change in color reaction. The novel thermally-responsive record material includes a combination of bis(4-hydroxy-3-allylphenyl) sulphone together with a compound of the formula: 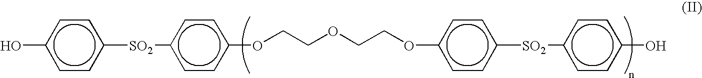
where n is an integer from about 1 to 3, preferably 1 to 3, and most preferably n is 2 or averages around 2.

Compounds I and II are known materials available from chemical specialty manufacturers, or alternatively would be able to be synthesized by one skilled in the art.

Compounds according to formula II can be synthesized by using the methods as described in U.S. Pat. No. 5,801,288, and U.S. Pat. No. 6,103,661, incorporated herein by reference.

The compound according to the formula II can also be purchased commercially, (Trademark: “D-90”, sold by Nippon Soda Co., Ltd.) or can be synthesized from starting materials such as 4-benzyloxy-4′-hydroxydiphenyl sulfone and 1,1′-oxybis(2-chloroethane). Following reaction of theses two materials, the resultant material is phase extracted in hot solvent such as methyl isobutyl ketone and cooled to form the final product.

Bis(4-hydroxy-3-allylphenyl) sulphone is available commercially from vendors such as Nippon Kayaku Co., Ltd. (Trademark: “TGSA”). This material also can be synthesized from starting materials of 4,4′-sulfonyldiphenol or its alkali metal salt with a halogenated allyl compound in the presence of catalyst. The resultant material is heated in excess of 200 C for a rearrangement to form the final product.

Other synthetic routes to bis(4-hydroxy-3-allylphenyl) sulphone are described in patents such as U.S. Pat. Nos. 6,114,282 and 4,596,997 incorporated herein by reference.

One route to compound I is by reacting 4,4′-sulfonyldiphenol (25 parts) with allyl-p-toluene sulfonate (44 parts) in the presence of potassium carbonate (15.2 parts) in a solvent such as dimethylformamide (100 parts). Heat at 110° for 8 hours. Distill the solvent, heating and stirring at 200° C. for 6 hours. Add 60 parts trichlorobenzene and cool to ambient temperature with stirring. Filter to recover precipitated bis(4-hydroxy-3-allylphenyl) sulphone.

A route to compound II is dissolving 8.0 grams of sodium hydroxide in 100 ml. Of water. Add 0.16 mol of 4-benzyloxy-4′-hydroxydiphenyl sulfone. Add 100 ml of methyl isobutyl ketone and 0.04 mol 1,1-oxybis(2-chloroethane). Reflux for 15 hours. Acidify the water layer with dilute sulfonic acid to induce separation of the water layer. Wash the organic layer with 1% NaOH.

Other synthetic routes would be apparent to the artisan having skill in the synthetic arts. The invention resides in the surprising image retention achievable by combination of these materials in the color-forming composition coating of a thermally imaging record material. This image retention characteristic is not observed when the materials are used alone.

The invention comprises a thermally sensitive color-forming composition comprising electron donating dye precursor (chromogenic material) and acidic developer material compromising a combination of compounds I and II and binder material. The unexpected feature of this composition is that the inclusion of the combination of compounds of the invention facilitates the color-forming reaction resulting in a more intense image or faster imaging by image formation at lower temperatures. The image is resistant to fade when subjected to environmental challenges such as lotion or oil. The record material according to the invention has a non-reversible image in that under normal use conditions such as a record of a transaction, it is substantially non-reversible and stable for many months or even years. The coating of the record material of the invention is basically a dewatered solid at ambient temperature and differs from reversible solvent liquid based compositions such as taught by Kito et al., in U.S. Pat. Nos. 4,720,301 and 4,732,810 which erase upon exposure to elevated temperature from 20° C. to 50° C. The image herein formed is non-reversible at such temperature. The color-forming composition (or system) of the record material of this invention comprises chromogenic material (electron-donating dye precursor) in its substantially colorless state, and acidic developer material comprising the combination of compounds I and II. The color-forming system relies upon melting, softening, or subliming one or more of the components to achieve reactive, color-producing contact.

The record material includes a substrate or support material which is generally in sheet form. For purposes of this invention, sheets can be referred to as support members and are understood to also mean webs, ribbons, tapes, belts, films, cards and the like. Sheets denote articles having two large surface dimensions and a comparatively small thickness dimension. The substrate or support material can be opaque, transparent or translucent and could, itself, be colored or not. The material can be fibrous including, for example, paper and filamentous synthetic materials. It can be a film including, for example, cellophane and synthetic polymeric sheets cast, extruded, or otherwise formed. The gist of this invention resides in the color-forming composition coated on the substrate. The kind or type of substrate material is not critical.

The components of the color-forming system are in substantially contiguous relationship, substantially homogeneously distributed throughout the coated layer or layers of material deposited on the substrate.

The term substantially contiguous relationship is understood to mean that the color-forming components are positioned in sufficient proximity such that upon melting, softening or subliming one or more of the components a reactive color-forming contact between the components is achieved. As is readily apparent to the person of ordinary skill in the art, these reactive components accordingly can be in the same coated layer or layers, or isolated or positioned in separate layers. In other words, one component such as the chromogen can be positioned in the first layer, and reactive or sensitizer components, such as either or both of the compounds I and II or acidic developer, positioned in a subsequent layer or layers. The coating can optionally be applied to all of the substrate or spot printed on a certain portion. All such arrangements are understood herein as being substantially contiguous and would be readily apparent to the skilled artisan.

The thermal record material can optionally include a variety of precoats such as a base layer of clay, and absorptive pigments such as kaolin clays, insulators such as hollow sphere particles, pigments, particulate clays, starch, or synthetic polymeric materials. Hollow sphere particles are commercially available such as the “Ropaque” materials of Rohm and Haas.

Optionally, the thermally-sensitive color-forming composition can be formed as a top layer on the substrate which top layer is then overcoated with a protective layer top coat or barrier layer formed from one or more water soluble or dispersible polymeric materials such as polyvinyl alcohol, carboxylated polyvinyl alcohol, methyl or ethyl cellulose, polyacrylamide, gelatin, starch or polyvinyl pyrrolidone.

Optionally, a protective layer using the same or different materials can be applied as a back coat to the thermally-sensitive record material. The materials indicated as useful as precoats, such as the hollow sphere particles, pigments, clays and synthetic polymeric particulate materials can also be usefully applied as the back coat.

In manufacturing the record material, a coating composition is prepared which includes a fine dispersion of the components of the color-forming system, polymeric binder material, surface active agents and other additives in an aqueous coating medium. The color-forming composition can additionally contain inert pigments, such as clay, talc, aluminum hydroxide, calcined kaolin clay and calcium carbonate; synthetic pigments, such as urea-formaldehyde resin pigments; natural waxes such as Camuba wax; synthetic waxes; lubricants such as a zinc stearate; wetting agents; defoamers, and antioxidants. Sensitizers can also be included. Sensitizers for example, can include acetoacet-o-toluidine, phenyl-1-hydroxy-2-naphthoate, 1,2-diphenoxyethane, or p-benzylbiphenyl or mixtures thereof. The sensitizer or modifier typically does not impart significant imaging on its own, but as a relatively low melt point solid, acts as a solvent to facilitate reaction between the color-forming components of the color-forming system.

The color-forming system components are substantially insoluble in the dispersion vehicle (preferably water) and are ground to an individual average particle size of between about 1 micron to about 10 microns, preferably about 1-3 microns. The polymeric binder material is substantially vehicle soluble although latexes are also eligible in some instances. Preferred water soluble binders include polyvinyl alcohol, hydroxy ethyl-cellulose, methylcellulose, methyl-hydroxypropylcellulose, starch, modified starches, gelatin and the like. Eligible latex materials include polyacrylates, sytrene-butadiene-rubber latexes, polyvinylacetates, polystyrene, and the like. The polymeric binder is used to protect the coated materials from brushing and handling forces occasioned by storage and use of thermal sheets. Binder should be present in an amount to afford such protection and in an amount less than will interfere with achieving reactive contact between color-forming reactive materials.

Coating weights can effectively be about 3 to about 9 grams per square meter (gsm) and preferably about 5 to about 6 gsm. The practical amount of color-forming materials is controlled by economic considerations, functional parameters and desired handling characteristics of the coated sheets.

Eligible election-donating dye precursors are chromogenic material. Chromogenic materials such as the phthalide, leucauramine and fluoran compounds, for use in the color-forming system are well known color-forming compounds. Examples of the compounds include Crystal Violet Lactone (3,3-bis(4-dimethylaminophenyl)-6-dimethylaminophthalide, U.S. Pat. No. RE 23,024); phenyl-, indol-, pyrrol-, and carbazol-substituted phthalides (for example, in U.S. Pat. Nos. 3,491,111; 3,491,112; 3,491,116; 3,509,174); nitro-, amino-, amido-, sulfon amido-, aminobenzylidene-, halo-, anilino-substituted fluorans (for example, the U.S. Pat. Nos. 3,624,107; 3,627,787; 3,641,011; 3,642,828; 3,681,390); spirodipyrans (U.S. Pat. No. 3,971,808); and pyridine and pyrazine compounds (for example, in U.S. Pat. Nos. 3,775,424 and 3,853,869). Other specifically eligible chromogenic compounds, not limiting the invention in any way, are: 3-diethylamino-6-methyl-7-anilino-flouran (U.S. Pat. No. 4,510,513) also known as 3-dibutylamino-6-methyl-7-anilino-fluoran; 3-dibutylamino-7-(2-chloroanilino) fluoran; 3-(N-ethyl-N-tetrahydrofurfurylamino)-6-methyl-7-3,5′6-tris(dimethylamino)spiro[9H-fluorene-9,1′(3′H)-isobenzofuran]-3′-one; 7-(1-ethyl-2-methylindol-3-yl)-7-(2-chloroanilino) fluoran (U.S. Pat. No. 3,920,510); 3-(N-methylcyclohexylamino)-6-methyl-7-anilinofluoran (U.S. Pat. No. 3,959,571); 7-(1-octyl-2-methylindol-3-yl)-7-(4-diethylamino-2-ethoxyphenyl)-5,7-dihydrofuro[3,4-b]pyridin-5-one; 3-diethylamino-7,8-benzofluoran; 3,3-bis(1-ethyl-2-methylindol-3-yl)phthalide; 3-diethylamino-7-anilinofluoran; 3-diethylamino-7-benzylaminofluoran; 3′-phenyl-7-dibenzylamino-2,2′-spirodi-[2-H-1-benzopyran] and mixtures of any of the above.

Other known developer materials may also be included provided not used in an amount so as to detract from the functionality of the combination of the invention. Other acidic developer materials include the compounds listed in U.S. Pat. No. 3,539,375 as phenolic reactive material, particularly the monophenols and diphenols. Acidic developer materials also include, the following compounds: 4,4′-isopropylidinediphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicyanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4′-methylbenzophenone; 4,4′-dihydroxybenzophenone; 2,2-bis(4-hydroxyphenyl)-4-methylpentane; benzyl 4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl) pentanoate; alkyl-4,4-bis(4-hydroxyphenyl) pentanoate; 3,3-bis(4-hydroxyphenyl)(-pentane; 4,4-bis(4-hydroxyphenyl)-heptane; 2,2-bis(4-hydroxypheyl)-1-phenylpropane; 2,2-bis(4-hydroxyphenyl)butane; 2,2′-methylene-bis(4-ethyl-6-tertiarybutyl phenol); 4-hydroxycoumarin; 7-hydroxy-4-methylcoumarin; 2,2′-methylene-bis(4-octyl phenol); 4,4′-sulfonyldiphenol; 4,4′-thiobis(6-tertiarybutyl-m-cresol); methyl-p-hydroxybenzoate; n-propyl-p-hydroxybenzoate; and benzyl-p-hydroxybenzoate.

Examples of other developer compounds include phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, aftapulgite, hallosyte, and the like. Some of the polymers and minerals do not melt but undergo color reaction on fusion of the chromogen.

The following examples are given to illustrate some of the features of the present and should not be considered as limiting. In these examples all parts or proportions are by weight and all measurements are in the metric system, unless otherwise stated.

In all examples illustrated in the present invention, a dispersion of a particular system component, was prepared by milling the component in an aqueous solution of the binder until a particle size of between about 1 micron and 10 microns was achieved. The milling was accomplished in an attritor or other suitable milling device. The desired average particle size was about 1-3 microns in each dispersion.

The thermally-responsive sheets were made by making a coating dispersion. The dispersion was applied to a support with a wire wound rod and dried. Other materials such as fillers, antioxidants, lubricants and waxes can be added to the dispersion if desired. The sheets may be calendered to improve smoothness.

Nontopcoated sheets with heat-sensitive emulsion were made and exposed to oil and hand lotion containing α-hyroxyacid. One large mixture of all active components with the exception of the developer material blend of compounds I and II was made in the following manner:

| Component | % Solids | Weight (g) |
|---|---|---|
| calcium carbonates | 30 | 75 |
| amorphous silicon dioxide | 20 | 15 |
| 1,2-diphenoxyethane | 44 | 6 |
| Polyvinylalcohol | 10 | 150 |
| Zinc stearate | 44 | 5 |
| Stilbene fluorescent brightener | 17 | 1.3 |
| 3-Dibutylamino-6-methyl-7-anilinofluoran | 41 | 18 |

The above slurry was separated into 7 equal parts, each weighting 40 g. Coreactant or coreactant blends of compounds I and II were added to complete each variation as follows:

| Example | Coreactant | Weight (g) |
|---|---|---|
| 1 | 4,4′-(1-methylethylidene) bisphenol | 5 |
| 2 | bis(4-hydroxy-3-allylphenyl)sulphone | 5 |
| | (Compound 1) | |
| 3 | 4-hydroxy-4′-isopropoxy diphenyl sulfone | 5 |
| 4 | 4,4′-sulfonylbisphenol/1,1′-oxybis | 5 |
| | (2-chloroethane) polymer (Compound II) | |
| 5 | Variation 1 plus Compound II | 3.75/1.25 |
| 6 | Compound I and Compound II | 3.75/1.25 |
| 7 | Variation 3 plus Compound II | 3.75/1.25 |

All examples were coated on standard basecoated label stock at ˜2.0 lbs./ream (3.0 g/m²). The coated sheets were printed on a Hobart printer at 1.2 watts/dot and on an Atlantek 400-medium. Each set was read for initial values on a Webscan—670 nm verifier (for barcodes) and a Mac Beth densitometer (for block density). Each example coated sheet was exposed to vegetable oil and hand lotion (containing α-hydroxyacids) for 24 hours. At the end of 24 hours, the samples were wiped to remove any excess oil or lotion and re-read on the respective instruments to determine the amount of image lost. The results are summarized in the following table:

| | | | | | |
|---|---|---|---|---|---|
| Ex- | | | | | % |
| ample | Description | Initial | Final | Loss | Loss |

Hand Lotion Challenge

| | | Mac Beth Density Values | | | |
|---|---|---|---|---|---|
| 1 | 4,4′-(1-methylethylidene) bisphenol | 1.08 | 0.10 | 0.98 | 91 |
| 2 | Bis(4-hydroxy-3-allylphenyl) | 1.13 | 0.38 | 0.75 | 66 |
| | sulphone (Compound I) | | | | |
| 3 | 4-hydroxy-4′-isopropoxy diphenyl | 1.10 | 0.23 | 0.87 | 79 |
| | sulfone | | | | |
| 4 | 4,4′-sulfonylbisphenol/1,1′-oxybis | 0.78 | 0.32 | 0.46 | 59 |
| | (2-chloroethane) polymer | | | | |
| | (Compound II) | | | | |
| 5 | Example 1 plus Compound II | 0.82 | 0.20 | 0.62 | 76 |
| 6 | Compound I and Compound II | 1.10 | 0.81 | 0.29 | 26 |
| 7 | Example 3 plus Compound II | 0.97 | 0.33 | 0.64 | 66 |
| | | Decodability | | | |
| 1 | 4,4′-(1-methylethylidene) bisphenol | 73 | 0 | 73 | 100 |
| 2 | Bis(4-hydroxy-3-allylphenyl) | 78 | 0 | 78 | 100 |
| | sulphone (Compound I) | | | | |
| 3 | 4-hydroxy-4′-isopropoxy diphenyl | 75 | 0 | 75 | 100 |
| | sulfone | | | | |
| 4 | 4,4′-sulfonylbisphenol/1,1′-oxybis | 72 | 40 | 32 | 44 |
| | (2-chloroethane) polymer | | | | |
| | (Compound II) | | | | |
| 5 | Example I plus Compound II | 73 | 0 | 73 | 100 |
| 6 | Compound I and Compound II | 76 | 64 | 12 | 16 |
| 7 | Example 3 plus Compound II | 72 | 10 | 62 | 86 |

Oil Challenge

| | | Mac Beth Values | | | |
|---|---|---|---|---|---|
| 1 | 4,4′-(1-methylethylidene) bisphenol | 1.08 | 0.14 | 0.94 | 87 |
| 2 | Bis(4-hydroxy-3-allylphenyl) | 1.13 | 0.34 | 0.79 | 70 |
| | sulphone (Compound I) | | | | |
| 3 | 4-hydroxy-4′-isopropoxy diphenyl | 1.10 | 0.15 | 0.95 | 86 |
| | sulfone | | | | |
| 4 | 4,4′-sulfonylbisphenol/1,1′-oxybis | 0.78 | 0.53 | 0.25 | 32 |
| | (2-chloroethane) polymer | | | | |
| | (Compound II) | | | | |
| 5 | Example I plus Compound II | 0.82 | 0.43 | 0.39 | 48 |
| 6 | Compound I and Compound II | 1.10 | 0.77 | 0.33 | 30 |
| 7 | Example 3 plus Compound II | 0.97 | 0.49 | 0.48 | 49 |
| | | Decodability | | | |
| 1 | 4,4′-(1-methylethylidene) bisphenol | 73 | 0 | 73 | 100 |
| 2 | Bis(4-hydroxy-3-allylphenyl) | 78 | 0 | 78 | 100 |
| | sulphone (Compound I) | | | | |
| 3 | 4-hydroxy-4′-isopropoxy diphenyl | 75 | 0 | 75 | 100 |
| | sulfone | | | | |
| 4 | 4,4′-sulfonylbisphenol/1,1′-oxybis | 72 | 0 | 72 | 100 |
| | (2-chloroethane) polymer | | | | |
| | (Compound II) | | | | |
| 5 | Example I plus Compound II | 73 | 0 | 73 | 100 |
| 6 | Compound I and Compound II | 76 | 62 | 14 | 18 |
| 7 | Example 3 plus Compound II | 72 | 0 | 72 | 100 |

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive variations and changes can be made by those skilled in the art without departing from the spirit and scope of the invention.

1. A thermally-responsive record material comprising a support having provided thereon a color-forming composition comprising chromogenic material and bis (4-hydroxy-3-allylphenyl) sulphone in combination with a compound of formula: 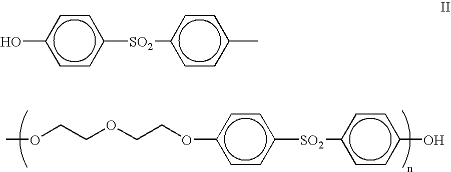
wherein n in an integer from about 1 to 3.

2. The thermally-responsive record material according to claim 1 wherein n is 2.

3. The thermally-responsive record material according to claim 1 wherein the compound of formula II is a blend of compounds of formula II with n averaging about 2.

4. The thermally-responsive record material according to claim 1 including in addition 4,4′-sulfonyl bisphenol.

5. The thermally-responsive record material according to claim 1 wherein the thermally-responsive record material includes in addition a topcoat selected from polyvinyl alcohol, carboxylated polyvinylalcohol, methylcellulose, ethyl cellulose, polyacrylamide, gelatin, starch, and polyvinyl pyrrolidone.

6. The thermally responsive record material according to claim 1 wherein the chromogenic material comprises a fluoran.

7. The thermally-responsive record material according to claim 1 wherein the chromogenic material comprises 3-dibutylamino-6-methyl-7-anilino fluoran.

8. The thermally-responsive record material according to claim 1 wherein the color-forming composition includes in addition a sensitizer.

9. The thermally-responsive record material according to claim 8 wherein the color-forming composition includes in addition a sensitizer selected from 1,2-diphenoxyethane, acetoacet-o-toluidine, phenyl-1-hydroxy-2-naphthoate, and p-benzyl biphenyl.

10. The thermally-responsive record material according to claim 1 wherein the thermally responsive record material includes in addition a backcoat.

11. The thermally-responsive record material according to claim 1 wherein the color-forming composition comprises one or more layers coated on the support.

12. The thermally-responsive record material according to claim 11 wherein the support is paper.

13. The thermally-responsive record material according to claim 11 wherein the chromogenic material is positioned in a separate layer from the compound of formula II.
